(19) United States
(12) Patent Application Publication
(10) Pub. No.: US 2018/0030991 A1
(43) Pub. Date: Feb. 1, 2018

(54) METHODS FOR REPAIRING OR RESTORING IMPELLER SEALS OF A CENTRIFUGAL COMPRESSOR

(71) Applicant: SIEMENS DEMAG DELAVAL TURBOMACHINERY, INC., Trenton, NJ (US)

(72) Inventors: Murat Acar, Yardley, PA (US); Donald Guttshall, Morrisville, PA (US)

(21) Appl. No.: 15/223,413

(22) Filed: Jul. 29, 2016

(51) Int. Cl. F04D 29/16; F04D 27/00; F04D 29/62; F04D 29/28

(52) U.S. Cl. CPC F04D 29/162; F04D 29/284; F04D 27/001; F04D 29/624; F05B 2230/10; F05B 2230/234; F05B 2230/40

(57) ABSTRACT

A method of repairing or restoring an impeller seal tooth is provided. The method includes the step of inspecting each tooth of the impeller seal to determine what portions of the tooth requires repair. To repair the tooth, the worn portions may be removed via a pre-machining process to a base of the tooth, or other weldable surface of the tooth. The method further includes applying a weld to the weldable surface, via a pulsed laser beam welding process, to build up the weld into a substantially tapered shape corresponding to a shape of a restored seal tooth. After building the weld into the tapered shape, the method includes machining the tapered shaped into the restored seal tooth, and testing the restored seal tooth via a balance and speed testing.

### TECHNICAL FIELD

This present disclosure relates generally to centrifugal compressors, and more particularly, to methods for repairing seal teeth on centrifugal compressor impellers.

### BACKGROUND

In centrifugal compressors, labyrinth seals are commonly utilized to help minimize leakage in the gas flow path. The seals generally include teeth that rotate relative to a surrounding seal land, and are typically worn out by time in service during the relative rotation, or are damaged by foreign particles, both of which may result in increased leakage. As a result of the increased leakage, repairing or restoring the impeller is required, as it is more economical than replacement. During the repair process, certain impeller dimensions, e.g., the area of the discharge opening, the inner bore diameter, and the seal diameter, with close tolerances must be maintained during the repair process. Maintaining these impeller dimensions is critical for assembly and performance of the impeller during operation. Common repair methods with arc welding techniques include building weld overlays on an impeller eye of impeller, and later reshaping the weld overlays, via a machining process, into a shape of the impeller teeth. Unfortunately, these common repair methods causes a change in the impeller dimensions as heat is introduced into the impeller bore, which leads to a distortion of the impeller bore. Because of the distortion, the impeller bore requires welding, which leads to additional downtime of the compressor due to the additional welding procedure, and an increase in the amount of weld needed to complete the weld operation.

Therefore, there remains a need for an improved method which eliminates distortion, e.g., of the impeller bore when repairing the seal teeth, and reduces downtime of the compressor and decrease the amount of weld needed for the repair process.

### SUMMARY

In one exemplary embodiment, a method for repairing or restoring a tooth for an impeller seal is provided. The method includes the step of inspecting the impeller seal tooth and determining what portions of the impeller seal tooth to repair or restore.

The method also includes the step of removing the worn portions of the impeller seal tooth, i.e., the portions determined as requiring repair. After removing the worn portions, the method includes the step of forming a weld into a tapered shape that corresponds with a shape of a fully repaired/restored seal tooth. The weld is formed via a pulsed laser beam welding process (LBW), e.g., by introducing a minimal heat onto a weldable surface of a base of the seal tooth to be repaired. By introducing a minimal heat, via the LBW process, the impeller bore does not require further welding as a result of forming the weld in the tapered shape.

The method further includes the step of smoothing the tapered shape weld into a final repaired seal tooth shape, and subsequently, testing the repaired seal tooth via a balance and speed testing.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 is a sectional schematic cross-sectional view of a multi-staged centrifugal compressor, in accordance with the disclosure provided herein;

FIG. 2 is a sectional side view of seal teeth on an impeller in a compressor stage of the compressor of FIG. 1, in accordance with the disclosure provided herein;

FIG. 3A is a schematic cross-sectional view of a partially damaged tooth of the impeller, in accordance with the disclosure provided herein;

FIG. 3B is a second schematic cross-sectional view of a damaged tooth, in accordance with the disclosure provided herein;

FIG. 4 is a flowchart for an embodiment of a method for repairing/restoring an impeller seal tooth, in accordance with the disclosure provided herein.

### DETAILED DESCRIPTION

The components and materials described hereinafter as making up the various embodiments are intended to be illustrative and not restrictive. Many suitable components and materials that would perform the same or a similar function as the materials described herein are intended to be embraced within the scope of embodiments of the present invention.

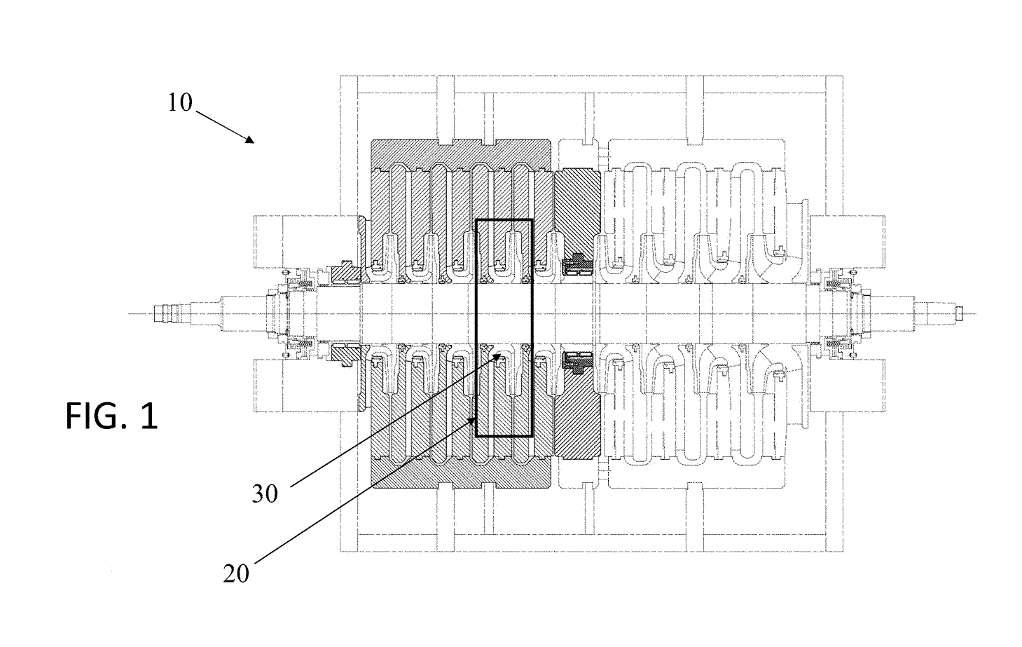

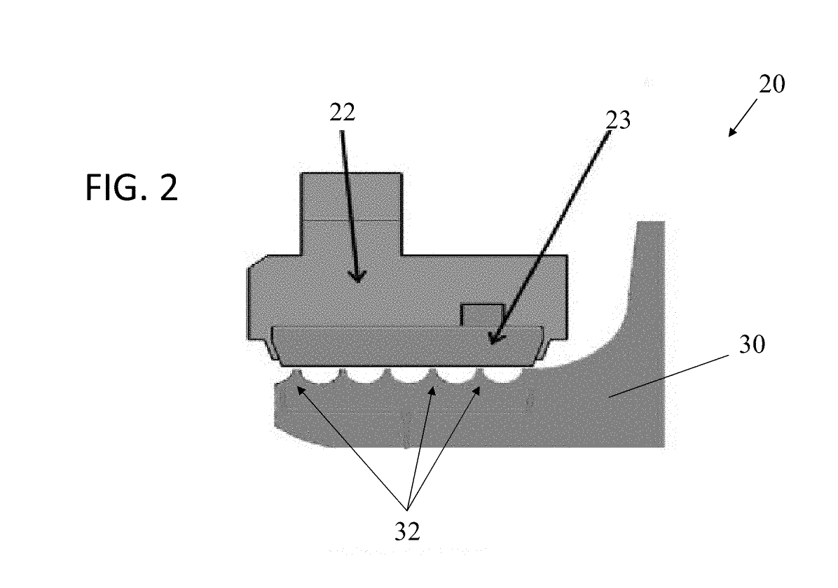

Referring now to the drawings wherein the showings are for purposes of illustrating embodiments of the subject matter herein only and not for limiting the same, FIG. 1 illustrates a sectional schematic cross-sectional view of a multi-staged centrifugal compressor 10 comprised of one or more compression stages 20. Each compression stage 20 may include one or more impellers 30 (FIG. 2), which may be attached to a shaft and are the rotating wheels directing a gas flow.

With continued reference to FIGS. 1 and 2, each impeller 30 may include an impeller seal, also referred to as a labyrinth seal 31, on an inlet side (eye) of the impeller 30. The labyrinth seal 31 may include at least one seal tooth 32 or a plurality of seal teeth 32, which in operation, e.g., seals against an abradable surface 23 of a ring 22 while preserving a mechanical contact in between. In one exemplary embodiment, the abradable surface 23 may be a surface of a stationary abradable insert ring 23 which may sit a steel backing ring 22 that holds the abradable material in place.

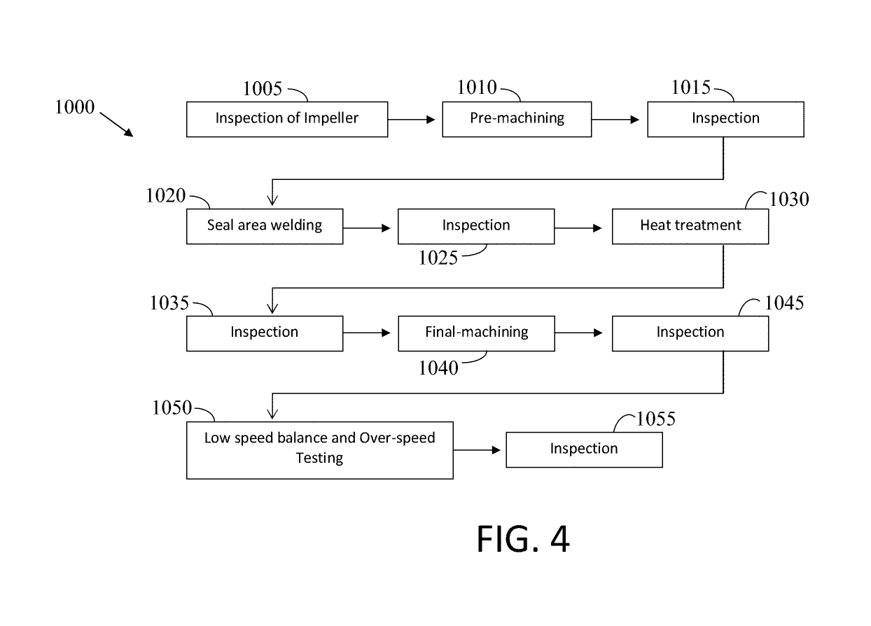

With continued reference to the figures and now FIG. 4, a flowchart for an exemplary embodiment of a method 1000 of repairing an impeller seal tooth 32 is provided. It should be appreciated that a full tooth or a portion of a tooth may be repaired via the methods described herein. Additionally or alternatively, multiple seal teeth may be repaired one after another or simultaneously.

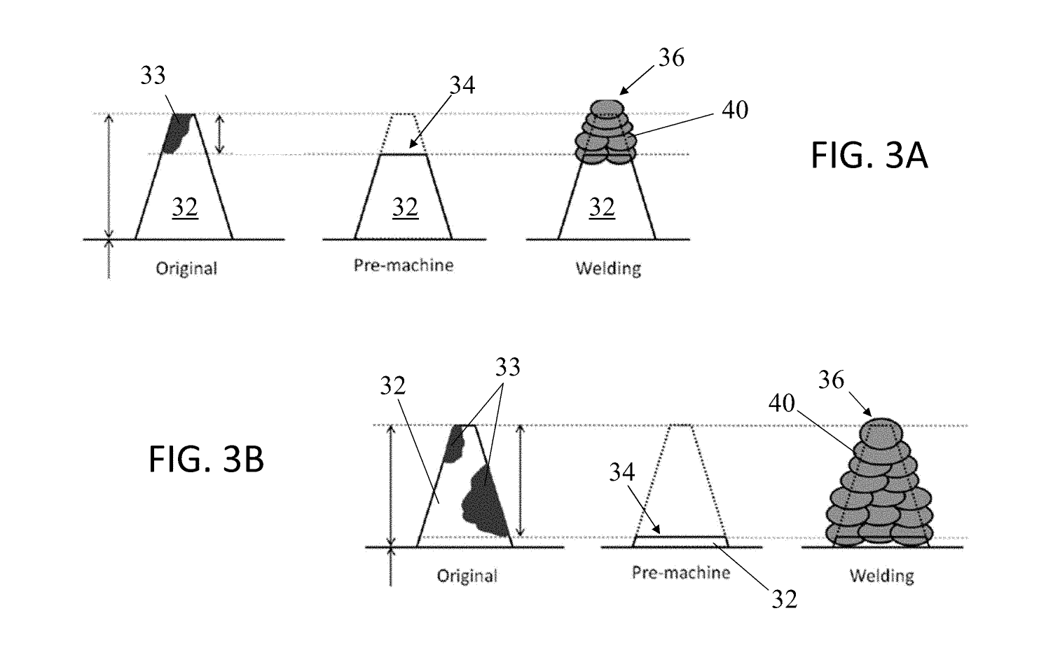

The repair restore process may proceed as follows: at least one or more teeth 32 of the impeller seal 31 may be inspected to determine if any portions 33 (FIG. 3A, 3B) of the tooth 32 is worn or damaged, thus requiring repair (1005). In this step, a visual or other known nondestructive inspection method may be performed to determine the condition of the seal tooth 32 and to determine what worn portions 33 of the tooth 32 should be repaired. For example, as shown in the embodiment of the tooth 32 in FIG. 3A, an inspection 1005 of the impeller seal 30 may identify that only a small portion 33 of the tooth 32 is damaged and requires repair, as compared to the embodiment of FIG. 3B, where an inspection 1005 may identify that a larger portion 33 than the portion of FIG. 3A is worn and requires repair. It should be appreciated that this larger portion 33 may affect (cover) a majority or all of the seal tooth 32, thus requiring that a majority of the seal tooth 32 be repaired/restored.

Upon determining what damaged/worn portions 33 require repair, the method 1000 includes the step of removing the worn portions 33 of the tooth 32 (1010). In one embodiment, a machining process (also called pre-machining) may be used to remove the worn portions 33 of the tooth 32 down to a weldable surface, shoulder, or reference point 34 of the tooth 32. It should be appreciated that pre-machining the worn portion 33 may continue until the weldable surface 34 of the tooth 32 is achieved.

With continued reference to the figures, in embodiments where a partial repair of the tooth 32 is desired (FIG. 3A), i.e., where the worn portions 33 merely covers a smaller area, the tooth 32 may be machined to a surface of the tooth 32 devoid of any damaged portions 33 and adapted for receiving a weld buildup 40 thereon.

Additionally or alternatively, where a full repair of the tooth 32 is desired (FIG. 3B), the worn portions 33 and the tooth 32 may be machined down to a base 34 of the worn tooth 32, with the base 34 providing the weldable surface 34 for receiving the weld buildup 40. After machining the worn portion 33 to the weldable surface 34, the machined tooth 32 or weldable surface 34 may be inspected (1015). It should be appreciated that the inspecting steps described in the method 1000, e.g., step 1015, may be optional performed, or may be applied at various points throughout the method 1000 without departing from the scope of the invention disclosed.

With continue reference to the figures, the method 1000 may include forming a weld onto the weldable surface 34 into a shape corresponding to a shape of a restored seal tooth (1020). In this step, instead of applying general layers of a weld as taught by the common methods of repair, the weld is applied or built up, via a pulsed laser beam welding (LBW) process, into a tapered or substantially tapered shape, e.g., from the weld surface 34 to a peak point 36 as determined by a restored seal tooth 32.

In one embodiment, the peak point 36 may be the point at the height of the seal tooth 32 from the base or root, e.g., where the seal tooth 32 in operations engages the abradable insert ring 23. As used herein, a tapered shape tooth may be a tooth shape where the lower portion (i.e., base) is generally wider than its upper portion (i.e., tip). This tapered shape is exemplified in FIG. 3, which illustrates the weld 40 being generally wider at or near the root of the tooth 32, i.e., the base of the tooth, and gradually decreasing in width as the weld 40 approaches the peak point 36, i.e., the tip of the tooth.

It should be appreciated that less material (weld) may be used for forming the weld into the tapered shape as compared to traditional methods, which requires a plurality of weld overlays be performed onto or across the seal teeth base for later machining the seal teeth shape out of the weld overlays. Additionally, it should be further appreciated that forming the tapered shape, via the LBW process, applies less heat to the impeller than the traditional repair methods, which reduces the likelihood of distorting the impeller dimensions, e.g., the impeller bore.

With continued reference to FIG. 4, the method 1000 may further include the step of smoothing the tapered shape of the seal tooth 32 into the restored seal tooth 32, e.g., into a seal tooth 32 ready for final inspection and use. In one embodiment, the smoothing step may include inspecting the tapered shape weld buildup 40 (1025); heat treating the tapered shape weld or portions thereof (1030); and machining the weld or portions into the restored seal tooth (1040). As previously stated, additionally or alternatively, further inspection steps may be implemented through the process, e.g., an inspection after heat treating the weld (1035) and after a final machining of the tooth 32 into the restored tooth (1045).

After machining the tapered shape weld into the restored seal tooth 32, the restored seal tooth 32 may be tested (1050). In this step, testing of the restored seal tooth 32 may include a balance and/or speed testing, e.g., a low-speed balance testing and an over-speed testing of the restored seal tooth 32. Upon completion of either testing or both, a further inspection (1055) may be conducted prior to returning the repaired impeller 30 to operation.

By using the above method(s), the need to weld the impeller bore in the prior-art methods to correct distortions is eliminated, as the amount of heat applied in the new method is reduced. Additionally, the amount of material for forming the repaired seal tooth in the new method is reduced by forming the weld into a shape that corresponds to a restored seal tooth.

The new method saves weld by eliminating the need to apply multiple weld overlays across the seal teeth as taught in the traditional arc welding process, and then reshaping the teeth only after solidification, as the new method forms the weld in the shape of a restored seal tooth, thus allowing an individual tooth to be restored.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the terms “comprising”, “including”, and “having”, are open-ended and does not exclude other elements or steps and the use of articles “a” or “an” does not exclude a plurality. Additionally, the steps of various methods disclosed herein are not required to be performed in the particular order recited, unless otherwise expressly stated.

We claim:

1. A method comprising:
removing worn portions of an impeller seal tooth to achieve a weldable surface of the seal tooth;
forming a weld, via a pulsed laser beam welding process, into a shape corresponding with a shape of a restored seal tooth onto the weldable surface; and
smoothing the weld into the restored seal tooth.

2. The method of claim 1, wherein the smoothing step comprises:
heat treating portions of the weld shape corresponding with the shape of the restored seal tooth; and
machining said heat treated portions until the seal tooth is restored.

3. The method of claim 2 further comprising:
inspecting the weld shape prior to heat treating the portions and after heat treating the portions of the weld shape.

4. The method of claim 3 further comprising:
inspecting the weld shape after machining said heat treated portions; and
balance and speed testing the restored seal tooth.

5. The method of claim 1 wherein the removing step comprises:
inspecting the seal tooth to determine the worn portions; and
machining the worn portions to the weldable surface.

6. The method of claim 5, wherein the weldable surface is at a base of the seal tooth.

7. The method of claim 1 further comprising:
balance and speed testing the impeller after smoothing the weld into the restored seal tooth.

8. The method of claim 7, wherein the balance and speed testing comprises a low speed balance testing or an over-speed balance testing.

9. The method of claim 7, wherein the balance and speed testing comprises a low speed balance testing and an over-speed testing.

10. The method of claim 1, wherein the forming step comprises: building the weld in a tapered shape from the weldable surface to a predetermined peak point.

11. The method of claim 10, wherein the peak point is a point where the restored seal tooth is adapted to engage an abradable insert ring.

12. A method for repairing or restoring a tooth of an impeller seal comprising:
forming a weld, via a pulsed laser beam welding process, into a substantially tapered shape corresponding to a restored seal tooth onto a weldable surface of the tooth to a peak point of the tooth; and
smoothing the substantially tapered shape into the restored seal tooth.

13. The method of claim 12, wherein the smoothing step comprises:
heat treating portions of the substantially tapered shape; and
machining said heat treated portions until the seal tooth is restored.

14. The method of claim 13 further comprising:
inspecting the tapered shape prior to heat treating said portions and prior to machining said heat treated portions.

15. The method of claim 14 further comprising:
inspecting the machined heat treated portions; and
balance and speed testing the restored seal tooth.

16. The method of claim 15, wherein the balance and speed testing comprises a low speed balance testing or an over-speed testing.

17. The method of claim 15, wherein the balance and speed testing comprises a low speed balance testing and an over-speed testing.

18. The method of claim 12 further comprising:
balance and speed testing the restored seal tooth.

19. The method of claim 18, wherein the balance and speed testing comprises a low speed balance testing or an over-speed testing.

20. The method of claim 18, wherein the balance and speed testing comprises a low speed balance testing and an over-speed testing.
